(19) United States
(12) Patent Application Publication
(10) Pub. No.: US 2022/0294297 A1
(43) Pub. Date: Sep. 15, 2022

(54) METHOD FOR MANUFACTURING STATOR COIL OF ROTATING ELECTRIC MACHINE AND STATOR COIL

(71) Applicant: IHI CORPORATION, Tokyo (JP)

(72) Inventor: Tetsuyuki TERAUCHI, Tokyo (JP)

(73) Assignee: IHI CORPORATION, Tokyo (JP)

(21) Appl. No.: 17/831,211

(22) Filed: Jun. 2, 2022

Related U.S. Application Data
(63) Continuation of application No. PCT/JP2021/000064, filed on Jan. 5, 2021.

(30) Foreign Application Priority Data
Feb. 27, 2020 (JP) 2020-032093

(51) Int. Cl. H02K 3/12; H02K 3/28; H02K 15/02

(52) U.S. Cl. CPC H02K 3/12; H02K 3/28; H02K 15/024

(57) ABSTRACT

When manufacturing a stator coil by assembling coil constituent members inserted into a plurality of axial slots formed in a cylindrical stator core of an AC power generator, respective end portions of the coil constituent members inserted into the respective slots and mutually arranged in a circumferential direction, which project on at least one end surface side of the stator core, are formed to be along the circumferential direction toward a mutually approaching direction, the end portions are formed to be shifted to each other in a radial direction, and end portions of the coil constituent members mutually arranged in the circumferential direction, which are shifted to each other in the radial direction, are overlapped with each other and joined. This makes it possible to compactify the stator coil, simplify a coil shape, and suppress stress caused by thermal contraction after welding.

### CROSS REFERENCE TO RELATED APPLICATIONS

This application is a bypass continuation of International Application No. PCT/JP2021/000064, filed on Jan. 5, 2021, which claims the benefit of Japanese Priority Patent Application No. 2020-032093 filed on Feb. 27, 2020, the entire contents of which are incorporated herein by reference.

### TECHNICAL FIELD

Embodiments described herein relate to a method for manufacturing a stator coil of a rotating electric machine such as an electric motor or a power generator, and a stator coil.

### BACKGROUND ART

It is known that such an electric motor as described above is, for example, an AC power generator mounted on an automobile, a truck or the like as described in Patent Document 1.

This AC power generator includes a cylindrical stator core made by stacking thin steel plates, and a stator coil forming a stator together with the stator core.

The cylindrical stator core includes a plurality of axial slots opened in an inner circumferential surface of the core. As the stator coil, an annular stator coil made by connecting a plurality of coil constituent members having a rectangular cross section is adopted.

Each coil constituent member of the stator coil includes a body part inserted into each slot of the stator core, and a projecting portion of the coil constituent member that is located on one end surface side of the stator core in a state where the body part is inserted into the slot, forms a coil end group together with respective projecting portions of the other annularly arranged coil constituent members.

In this case, in the slot of the stator core, body parts of two coil constituent members are inserted as an inner circumferential side and an outer circumferential side. In an inner circumferential side projecting portion and an outer circumferential side projecting portion that are located on the one end surface side of the stator core in the coil end group, inclined parts inclined in a circumferential direction and in mutually opposite directions and axially raised axial end portions are continuously formed.

Then, the axial end portions in different coil constituent members on different sides are joined to each other by welding along an axial welding line, to form the annular stator coil.

### RELATED ART DOCUMENT

### Patent Document

Patent Document 1: Japanese Patent Laid-Open No. 2000-069729

### SUMMARY OF THE DISCLOSURE

### Problems to be Solved by the Disclosure

In such a conventional stator coil manufacturing method as described above, as compared with a case of winding an electrical wire coated with an insulation coating film to form a stator coil, there is an advantage that it is easy to form regularly arranged coils. However, an axial end portion is raised to perform welding in an axial direction in a coil end group, and an axial length of the stator coil accordingly increases, which results in a problem that compactification is hindered.

It is considered that, to solve the above problem, in the coil end group, an inner circumferential side projecting portion and an outer circumferential side projecting portion are radially bent and joined by welding along a radial welding line. Alternatively, it may be considered that the inner circumferential side projecting portion and the outer circumferential side projecting portion are formed as butted end portions facing each other in circumferential opposite directions in the coil end group, and the butted end portions in different coil constituent members on different sides are joined by butt welding.

However, in a case of welding along the radial welding line described above, the inner circumferential side projecting portion and the outer circumferential side projecting portion are bent in a radial direction substantially orthogonal to a circumferential direction, and the coil is accordingly formed in a complicated shape.

In a case of joining the butted end portions in the coil constituent members to each other by the butt welding, there is a problem that thermal contraction caused between the welded butted end portions causes stress between a body part of each coil constituent member and a slot in a stator core that accommodates the body part, and a solution to this problem is conventionally sought.

An object of the present disclosure, which has been made to solve conventional problems described above, is to provide a method for manufacturing a stator coil of a rotating electric machine, and a stator coil, which make it possible to compact the stator coil, contribute to a simple coil shape, and minimize stress caused by thermal contraction after welding.

### Means for Solving the Problems

A first aspect of the present disclosure is directed to a configuration when manufacturing a stator coil by connecting coil constituent members inserted into a plurality of axial slots formed in a cylindrical stator core of a rotating electric machine, the configuration including forming respective end portions of the coil constituent members inserted into the respective axial slots and mutually arranged in a circumferential direction, which project on at least one end surface side of the stator core, such that the end portions are along the circumferential direction toward a mutually approaching direction and such that the end portions are shifted to each other in a radial direction, and overlapping and joining, to each other, the end portions of the coil constituent members mutually arranged in the circumferential direction, which are shifted to each other in the radial direction.

### Effects of the Disclosure

According to a method for manufacturing a stator coil of a rotating electric machine of the present disclosure, a very excellent effect of making it possible to compactify the stator coil, simplify a coil shape, and suppress stress caused by thermal contraction after welding is brought.

### BRIEF DESCRIPTION OF THE DRAWINGS

FIG. 1 is a partially cross-sectional explanatory view of a rotating electric machine showing an embodiment of a stator coil of the rotating electric machine according to the present disclosure.

FIG. 2 is a partially enlarged explanatory view of an inner circumferential surface of a stator core in a stator of the rotating electric machine shown in FIG. 1 seen from an axial center side.

FIG. 3 is a bird's eye view of the stator coil in the stator of the rotating electric machine shown in FIG. 1.

FIG. 4 is a partially enlarged plan explanatory view seen from a direction of an arrow B of FIG. 2.

FIG. 5 is a partially cross-sectional explanatory view of the stator core based on a position along the A-A line of FIG. 2.

### MODE FOR CARRYING OUT THE DISCLOSURE

Hereinafter, an embodiment of the present disclosure will be described with reference to the drawings.

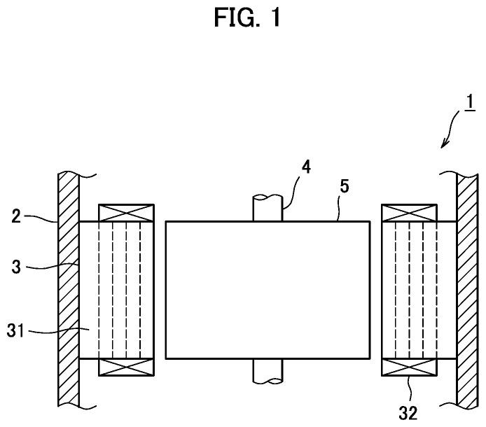

FIGS. 1 to 5 show the embodiment of a stator coil of a rotating electric machine according to the present disclosure. In the present embodiment, a case where a method for manufacturing the stator coil of the rotating electric machine according to the present disclosure is used in a stator coil of a three-phase AC power generator is described as an example.

As partially shown in FIG. 1, an AC power generator 1 includes a shell 2, a stator 3 as an armature supported by the shell 2, and a rotor 5 supported by the shell 2, similarly to the stator 3, to rotate integrally with a shaft 4.

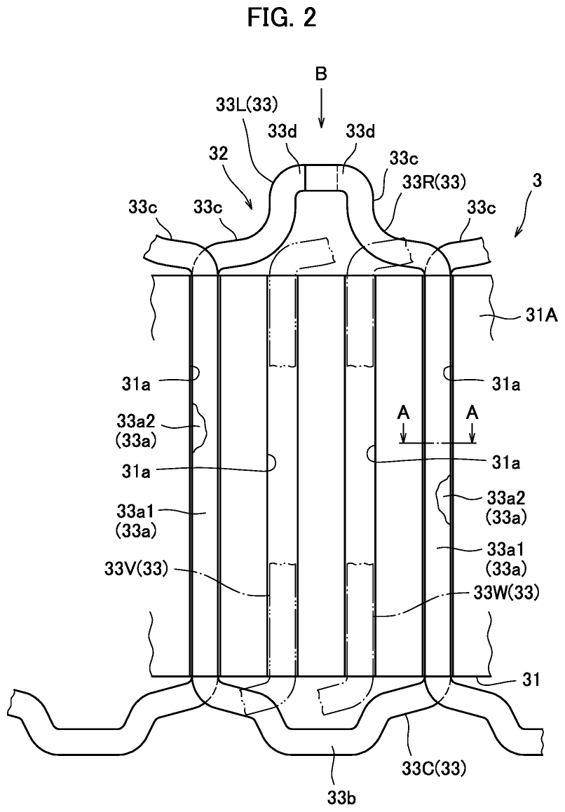

The stator 3 includes a cylindrical stator core 31. The stator core 31 is made by stacking thin steel plates and includes a plurality of axial slots 31a opened in an inner circumferential surface 31A of the stator core as shown in FIG. 2.

Also, the stator 3 includes stator coils 32 of three phases in total including a U-phase, a V-phase and a W-phase, the stator coils forming the stator 3 together with the stator core 31. The respective stator coils 32 of the U-phase, V-phase and W-phase have the same configuration. Therefore, hereinafter, description will be made as to the U-phase stator coil 32, and the V-phase and W-phase stator coils 32 are not described.

The stator coil 32 is made by connecting a plurality of coil constituent members 33, and in this embodiment, each coil constituent member 33 is made of an oxygen-free copper rod having a rectangular cross section. The coil constituent member 33 is formed substantially in a

U-shape by pressing. The coil constituent member 33 includes two body parts 33a and 33a and a returning portion 33b and is coated with an insulation film excluding after-mentioned joining end portions 33d.

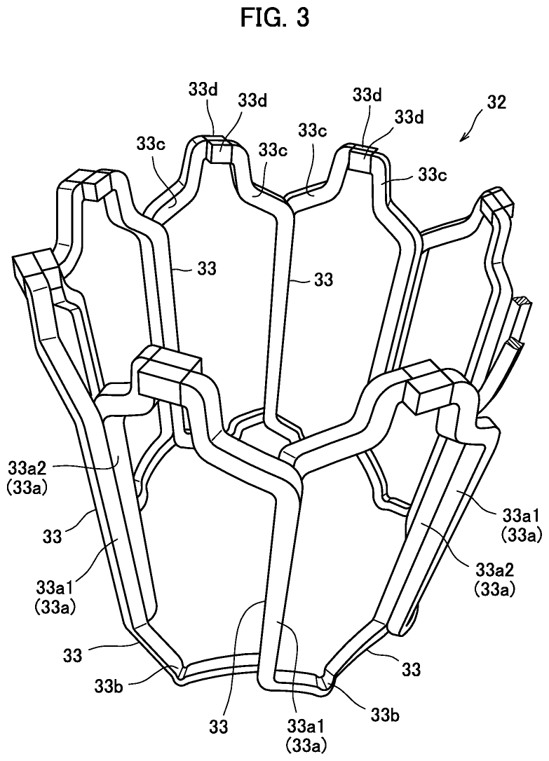

Also as shown in FIG. 3, the plurality of coil constituent members 33 are arranged such that a first body part 33a of the coil constituent member 33 overlaps with a second body part 33a in the coil constituent members 33 mutually arranged in a circumferential direction.

Specifically, the plurality of coil constituent members 33 are arranged in the circumferential direction such that a right body part 33a2 of a coil constituent member 33L (33) located on a left side in FIG. 2 overlaps with a shown back side of a left body part 33a1 of a coil constituent member 33C (33) located in a center of FIG. 2.

Similarly, the plurality of coil constituent members 33 are arranged in the circumferential direction such that the right body part 33a2 of the coil constituent member 33C (33) located in the center of FIG. 2 overlaps with a shown back side of the left body part 33a1 of a coil constituent member 33R (33) located on a right side in FIG. 2.

That is, in a state where the plurality of coil constituent members 33 are arranged in the circumferential direction, a first body part 33a2 of the coil constituent member 33 and a second body part 33a1 of the coil constituent member 33 located adjacent to the one body part are arranged and accommodated in a radial direction (a depth direction in FIG. 2) in the slot 31a for the U-phase.

In this case, in the state where the plurality of coil constituent members 33 are arranged in the circumferential direction as described above, respective tip end sides of the body parts 33a and 33a of the coil constituent members 33 accommodated in mutually different slots 31a project on a first end surface side (an upper end surface side of FIG. 2) of the stator core 31.

Both projecting portions 33c and 33c of the coil constituent member 33 are formed to be along the circumferential direction toward a direction to separate from each other, and respective tip end portions of the projecting portions 33c and 33c are formed as joining end portions 33d and 33d arranged to be shifted to each other in the radial direction in a state of being along the first end surface of the stator core 31.

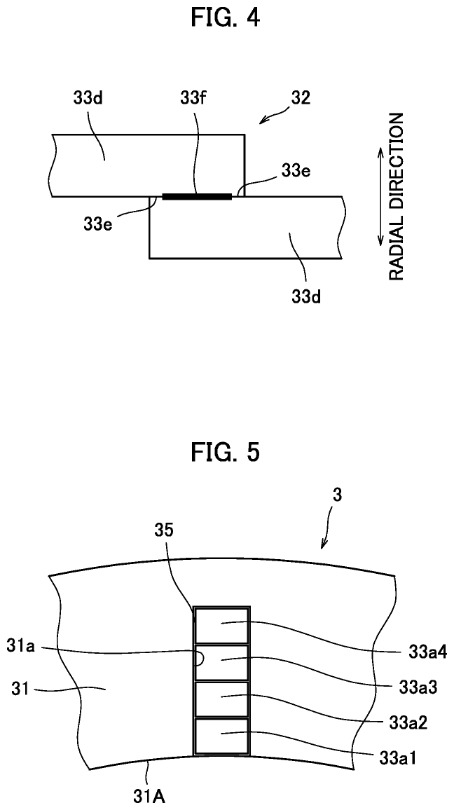

In this case, the respective joining end portions 33d and 33d, which are not coated with the insulation film, of the coil constituent members 33L and 33R located on the left and right in FIG. 2 overlap with each other in a state of being shifted to each other in the radial direction as shown in FIG. 4, above the returning portion 33b in the coil constituent member 33C in the center of FIG. 2 that projects on a second end surface side of the stator core 31 (a lower end surface side in FIG. 2). In a portion where the joining end portions 33d and 33d overlap with each other, the end portions are welded and joined along a welding line 33f set between opposite ends 33e, to electrically connect the coil constituent members 33L and 33R located on the left and right.

Then, the joining end portions 33d and 33d that overlap with each other in the state of being shifted to each other in the radial direction in a plurality of positions are welded and joined to each other in the same manner as described above, to be assembled into the annular stator coil 32.

Here, the returning portion 33b of the coil constituent member 33 substantially forms an S-shape in planar view, and the joining end portions 33d and 33d are joined to each other in the state of being shifted to each other in the radial direction, so that the stator coil 32 is formed in an annular shape without unevenness.

Furthermore, in this embodiment, another stator coil 32 having the same configuration is stacked on outside of the annular stator coil 32 assembled as described above and the stator coils are electrically continuous with each other. Specifically, as shown in FIG. 5, four body parts 33a are arranged and accommodated in the radial direction (an up-down direction in FIG. 5) in the slot 31a for the U-phase of the stator core 31. That is, a first body part 33a4 in the stator coil 32 stacked on the outside of the annular stator coil 32, and a second body part 33a3 are sequentially accommodated on a back side of the slot 31a for the U-phase. Then, the first body part 33a2 of the stator coil 32 located inside and the second body part 33a1 are sequentially accommodated on a front side of the slot 31a for the U-phase. Note that reference sign 35 in FIG. 5 denotes an insulating material.

Also, a double-dotted line in FIG. 2 shows a body part of a coil constituent member 33V for the V-phase inserted into the slot 31a for the V-phase. A one-dotted line in FIG. 2 shows a body part of a coil constituent member 33W for the W-phase inserted into the slot 31a for the W-phase.

Then, when manufacturing the annular stator coil 32 adopted in the AC power generator 1, the oxygen-free copper rod having the rectangular cross section is pressed with a press forming machine, to form the substantially U-shaped coil constituent member 33. In this case, the joining end portions 33d and 33d are also formed.

Next, the substantially U-shaped coil constituent member 33 obtained by the pressing is coated with the insulation film excluding the joining end portion 33d.

Afterward, the plurality of coil constituent members 33 are arranged in the circumferential direction such that the first body part 33a of the coil constituent member 33 overlaps with the second body part 33a of the coil constituent member 33 located adjacent to the one body part.

More specifically, the coil constituent members 33 are arranged in the circumferential direction such that the right body part 33a2 of the coil constituent member 33L (33) located on the left side in FIG. 2 overlaps with the shown back side of the left body part 33a1 of the coil constituent member 33C (33) located in the center of FIG. 2. Similarly, the coil constituent members 33 are arranged in the circumferential direction such that the right body part 33a2 of the coil constituent member 33C located in the center of FIG. 2 overlaps with the shown back side of the left body part 33a1 of the coil constituent member 33R (33) located on the right side in FIG. 2.

Next, in the state where the plurality of coil constituent members 33 are thus arranged in the circumferential direction, the respective joining end portions 33d and 33d of the coil constituent members 33L and 33R located on the left and right in FIG. 2 are located as shown above the returning portion 33b in the coil constituent member 33C of the center in FIG. 2. Then, as shown above the returning portion 33b, the joining end portions 33d and 33d overlap with each other in the state of being shifted to each other in the radial direction as shown in FIG. 4, and the joining end portions 33d and 33d are welded and joined, to electrically connect the coil constituent members 33L and 33R located on the left and right.

Then, similarly, the joining end portions 33d and 33d that overlap with each other in the state of being shifted to each other in the radial direction in the plurality of positions are welded and joined to each other, to be assembled into the annular stator coil 32.

As described above, in the method for manufacturing the stator coil according to this embodiment, the coil constituent members 33 forming the stator coil 32 are joined to each other, by welding and joining the joining end portions 33d and 33d that are shifted to each other in the radial direction and overlapped with each other.

Therefore, in the method for manufacturing the stator coil according to this embodiment, as shown in FIG. 4, stress caused by thermal contraction after the welding is applied in the radial direction, so that stress caused between the body part 33a of the coil constituent member 33 and the slot 31a of the stator core 31 that accommodates this body part can be minimized.

Also, in the method for manufacturing the stator coil according to this embodiment, the joining end portions 33d and 33d that join the coil constituent members 33 to each other are placed along the end surface of the stator core 31, so that an axial length of the stator coil 32 does not have to be increased, and the stator coil can be accordingly compactified.

Additionally, the joining end portion 33d does not have to be bent in the radial direction substantially orthogonal to the circumferential direction, and hence a complicated coil shape can be avoided.

Furthermore, in the method for manufacturing the stator coil according to this embodiment, the joining end portions 33d and 33d for joining the coil constituent members 33 to each other to form the stator coil 32 are joined by a joining method (high energy density joining method) such as high frequency fusing, laser beam welding, electron beam welding, or plasma arc welding. Therefore, processing with high density local heat input can be performed, and occurrence of damage to the insulation film can be avoided.

Additionally, in the method for manufacturing the stator coil according to this embodiment, the substantially U-shaped coil constituent member 33 including the joining end portion 33d is formed by the pressing with the press forming machine, which can contribute to facilitating of the manufacturing of the stator coil.

In the above embodiment, the case where the method for manufacturing the stator coil of the rotating electric machine according to the present disclosure is used in the three-phase AC power generator is described as the example, but the present disclosure is not limited to this example.

Also, in the above embodiment, the coil constituent member 33 forming the stator coil 32 substantially has the U-shape including the returning portion 33b, but the present disclosure is not limited to this example, and a structure for joining the joining end portions 33d and 33d to each other may be adopted in place of the returning portion 33b.

The method for manufacturing the stator coil of the rotating electric machine and the configuration of the stator coil according to the present disclosure are not limited to the above embodiment and can be variously modified without departing from the scope of the disclosure.

A first aspect of the present disclosure is directed to a configuration when manufacturing a stator coil by connecting coil constituent members inserted into a plurality of axial slots formed in a cylindrical stator core of a rotating electric machine, the configuration including forming respective end portions of the coil constituent members inserted into the respective axial slots and mutually arranged in a circumferential direction, which project on at least one end surface side of the stator core, such that the end portions are along the circumferential direction toward a mutually approaching direction and such that the end portions are shifted to each other in a radial direction, and overlapping and joining, to each other, the end portions of the coil constituent members mutually arranged in the circumferential direction, which are shifted to each other in the radial direction.

In the method for manufacturing the stator coil according to the first aspect, in a case where the end portions of the coil constituent members mutually arranged in the circumferential direction, which are shifted to each other in the radial direction, are overlapped and joined, for example, by welding, the stress caused by the thermal contraction after the welding is applied in the radial direction, so that stress caused between each coil constituent member and each slot of the stator core that accommodates this member can be minimized.

Also, in the method for manufacturing the stator coil according to this aspect, the end portions that join the coil constituent members to each other are formed to be along the circumferential direction toward the mutually approaching direction. That is, the end portions that join the coil constituent members to each other are formed to be along the end surface of the stator core, so that the axial length of the stator coil does not have to be increased, and the stator coil can be accordingly compactified.

Additionally, the end portion of the coil constituent member does not have to be bent in the radial direction substantially orthogonal to the circumferential direction, and the complicated coil shape can be avoided.

Also, a second aspect of the present disclosure is directed to a configuration where the end portions of the coil constituent members mutually arranged in the circumferential direction are overlapped with each other and joined with a high energy density joining method.

In the method for manufacturing the stator coil according to this aspect, the end portions for joining the coil constituent members forming the stator coil to each other are joined by the high energy density joining method with high energy density, so that the processing with high density local heat input can be performed, and the occurrence of damage to the insulation film can be avoided.

Furthermore, a third aspect of the present disclosure is directed to a configuration where the end portions of the coil constituent members are formed by press forming.

In the method for manufacturing the stator coil according to this aspect, the coil constituent members including the end portions are formed by pressing with a press forming machine, which can contribute to facilitating of the manufacturing of the stator coil.

A fourth aspect of the present disclosure is directed to a stator coil which forms a stator of a rotating electric machine together with a cylindrical stator core, the stator coil including a plurality of coil constituent members inserted into a plurality of axial slots formed in the stator core, wherein respective end portions of the coil constituent members inserted into the respective axial slots and mutually arranged in a circumferential direction, which project on at least one end surface side of the stator core, are formed to be along the circumferential direction toward a mutually approaching direction, and the end portions of the coil constituent members mutually arranged in the circumferential direction are overlapped with each other in a radial direction and joined.

In the stator coil according to this aspect, when joining the coil constituent members to each other, for example, by welding, the end portions of the coil constituent members mutually arranged in the circumferential direction are shifted to each other in the radial direction to be overlapped with each other and joined, so that stress caused by thermal contraction after the welding is applied in the radial direction, and stress caused between the coil constituent member and the slot in the stator core that accommodates this member can be minimized.

Further, in the stator coil according to this aspect, the end portions that join the coil constituent members to each other are along the circumferential direction toward the mutually approaching direction. Specifically, the end portions that join the coil constituent members to each other are along the end surface of the stator core, so that the axial length of the stator coil may be small, and the stator coil can be accordingly compactified. Additionally, a complicated coil shape can be avoided.

### EXPLANATION OF REFERENCE SIGNS

1 AC power generator (rotating electric machine)

3 stator

31 stator core

31a slot

32 stator coil

33 coil constituent member

33d joining end portion

1-4. (canceled)

5. A method for manufacturing a stator coil, when manufacturing the stator coil by connecting coil constituent members inserted into a plurality of axial slots formed in a cylindrical stator core of a rotating electric machine, the method comprising:
forming respective end portions of the coil constituent members inserted into the respective axial slots and mutually arranged in a circumferential direction, which project on at least one end surface side of the stator core, such that the end portions are along the circumferential direction toward a mutually approaching direction and along one end surface of the stator core and such that the end portions are shifted to each other in a radial direction, and
overlapping and joining, to each other, the end portions of the coil constituent members mutually arranged in the circumferential direction, which are shifted to each other in the radial direction.

6. The method for manufacturing the stator coil according to claim 5, wherein the end portions of the coil constituent members mutually arranged in the circumferential direction are overlapped with each other and joined with high energy density joining method.

7. The method for manufacturing the stator coil according to claim 5, wherein the end portions of the coil constituent members are formed by press forming.

8. The method for manufacturing the stator coil according to claim 6, wherein the end portions of the coil constituent members are formed by press forming.

9. A stator coil which forms a stator of a rotating electric machine together with a cylindrical stator core, the stator coil comprising:
a plurality of coil constituent members inserted into a plurality of axial slots formed in the stator core, wherein respective end portions of the coil constituent members inserted into the respective axial slots and mutually arranged in a circumferential direction, which project on at least one end surface side of the stator core, are formed to be along the circumferential direction toward a mutually approaching direction and along one end surface of the stator core, and
the end portions of the coil constituent members mutually arranged in the circumferential direction are overlapped with each other in a radial direction and joined.
